(19) United States
(12) Patent Application Publication
(10) Pub. No.: US 2021/0408519 A1
(43) Pub. Date: Dec. 30, 2021

(54) CATHODE FOR LITHIUM-AIR BATTERY HAVING LOW CELL RESISTANCE AND HIGH MECHANICAL PROPERTIES AND METHOD OF MANUFACTURING SAME

(71) Applicants: HYUNDAI MOTOR COMPANY, Seoul (KR); KIA MOTORS CORPORATION, Seoul (KR)

(72) Inventor: Gwang Seok Oh, Hwaseong-si (KR)

(73) Assignees: HYUNDAI MOTOR COMPANY, Seoul (KR); KIA MOTORS CORPORATION, Seoul (KR)

(21) Appl. No.: 17/137,814

(22) Filed: Dec. 30, 2020

(30) Foreign Application Priority Data
Jun. 26, 2020 (KR) 10-2020-0078240

(51) Int. Cl. H01M 4/133; H01M 12/08; H01M 4/62; H01M 4/04

(52) U.S. Cl. CPC H01M 4/133; H01M 12/08; H01M 2004/021; H01M 4/0416; H01M 4/625

(57) ABSTRACT

A cathode for a lithium-air battery having low cell resistance and superior mechanical properties is configured using an electrically conductive fibrous filler in lieu of a binder.

### CROSS REFERENCE TO RELATED APPLICATION

The present application claims priority to and the benefit of Korean Patent Application No. 10-2020-0078240, filed on Jun. 26, 2020, the entire contents of which are incorporated herein by reference.

### FIELD

The present disclosure relates to a cathode for a lithium-air battery having low cell resistance and superior mechanical properties.

### BACKGROUND

A lithium-air battery, which is one of the next-generation lithium batteries, is a system that uses oxygen in the air as a cathode active material. The lithium-air battery has capacity and energy density superior to those of a lithium-ion battery because it may receive an unlimited amount of oxygen from the air.

Charging and discharging of the lithium-air battery are performed through oxidation and reduction between lithium of the anode and oxygen of the cathode. During discharging, lithium ions oxidized at the anode pass through a separator via an electrolyte, move to the cathode, and meet with the reduced oxygen ions at the cathode to thereby produce lithium peroxide (Li₂O₂), which is a discharge product.

Meanwhile, in order to increase the energy density per unit weight of a lithium-air battery, a nano-sized carbon material having a large specific surface area is desired as a cathode material. Conventionally, a cathode is manufactured by bonding the cathode material with a binder. However, the binder, which is mostly a polymer material, is not electrically conductive, and thus acts as a resistor in the cell, and may be decomposed by oxygen radicals (O₂⁻) formed in the battery during charging and discharging, whereby the cathode may be deteriorated.

### SUMMARY

The present disclosure provides a cathode for a lithium-air battery having low cell resistance and a method of manufacturing the same.

The present disclosure provides a cathode for a lithium-air battery having superior mechanical properties and a method of manufacturing the same.

One form of the present disclosure provides a cathode for a lithium-air battery, including: a sheet layer including bundle-type carbon nanotubes and having a network structure formed by interconnecting the bundle-type carbon nanotubes; and a fibrous filler that is intertwined with the bundle-type carbon nanotubes in the sheet layer and is electrically conductive.

The bundle-type carbon nanotubes may include a plurality of carbon nanotube units that are aggregated, and the carbon nanotube units may have a diameter of 10 nm to 50 nm.

The carbon nanotube units may have a length of 100 nm to 5 μm.

The carbon nanotube units may have a specific surface area of 150 m²/g to 300 m²/g.

The bundle-type carbon nanotubes may have a diameter of 2 μm to 10 μm.

The bundle-type carbon nanotubes may have a length of 50 μm to 100 μm.

The fibrous filler may include at least one of carbon fiber, carbon nanofiber, vapor-grown carbon fiber (VGCF), silver wire, stainless wire, platinum wire or combinations thereof.

The fibrous filler may have a length of 1 mm to 10 mm.

The cathode may include 95 wt % to 98 wt % of the bundle-type carbon nanotubes and 2 wt % to 5 wt % of the fibrous filler.

The cathode may have a porosity of 75% to 90%.

Another form of the present disclosure provides a method of manufacturing a cathode for a lithium-air battery, including: preparing a solution by dispersing bundle-type carbon nanotubes and a fibrous filler in a solvent; and filtering the solution.

The solution may be prepared by mixing the bundle-type carbon nanotubes and the fibrous filler to produce a paste and then dispersing the paste in the solvent.

The bundle-type carbon nanotubes and the fibrous filler may be dispersed by irradiating the solution with ultrasonic waves.

The method may further include pressing the filtered product.

According to the present disclosure, a cathode for a lithium-air battery having low cell resistance may be obtained because a cathode is formed using an electrically conductive fibrous filler, rather than using a binder.

According to the present disclosure, a cathode for a lithium-air battery having improved mechanical properties, such as tensile strength, etc., may be obtained using a fibrous filler.

According to the present disclosure, a cathode for a lithium-air battery, which has superior mechanical properties and can thus maintain the structure thereof even upon expansion due to discharge products may be obtained.

According to the present disclosure, a cathode for a lithium-air battery, which has superior mechanical properties and is therefore advantageous for realizing a large area may be obtained.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a cross-sectional view showing a lithium-air battery according to the present disclosure;

FIG. 2 shows a cathode for a lithium-air battery according to the present disclosure;

FIG. 3 is a flowchart showing a process of manufacturing a cathode according to the present disclosure;

FIG. 4 is a scanning electron microscope (SEM) image showing the bundle-type carbon nanotubes used in Example of the present disclosure;

FIG. 5A is an SEM image showing the cathode for a lithium-air battery of Example 2 according to the present disclosure;

FIG. 5B is an SEM image showing the cathode of FIG. 5A after production of a discharge product;

FIG. 6A is an SEM image showing the cathode for a lithium-air battery of Comparative Example 1 according to the present disclosure; and

FIG. 6B is an SEM image showing the cathode of FIG. 6A after production of a discharge product.

The statements in this section merely provide background information related to the present disclosure and may not constitute prior art.

### DETAILED DESCRIPTION

The above and other objectives, features and advantages of the present disclosure will be more clearly understood from the following preferred forms taken in conjunction with the accompanying drawings. However, the present disclosure is not limited to the forms disclosed herein, and may be modified into different forms. These forms are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

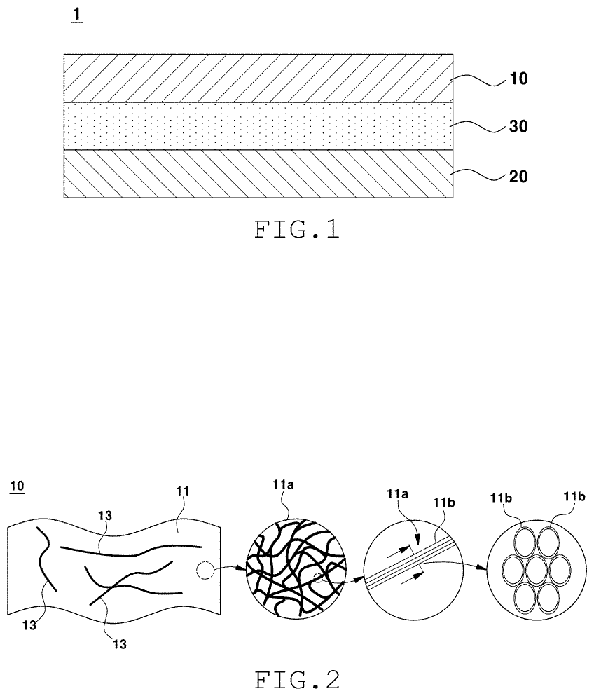

FIG. 1 is a cross-sectional view showing a lithium-air battery 1 according to the present disclosure. With reference thereto, the lithium-air battery 1 includes a cathode 10, an anode 20 and an electrolyte 30 loaded between the cathode 10 and the anode 20 or incorporated into at least one electrode.

FIG. 2 schematically shows the cathode 10 according to the present disclosure. With reference thereto, the cathode 10 may include a sheet layer 11 including bundle-type carbon nanotubes 11a and a fibrous filler 13 that is intertwined with the bundle-type carbon nanotubes 11a in the sheet layer 11.

As shown in FIG. 2, the sheet layer 11 may have a network structure formed by interconnecting the bundle-type carbon nanotubes 11a. Here, “network structure” means a structure formed by randomly interconnecting the bundle-type carbon nanotubes 11a.

As shown in FIG. 2, the bundle-type carbon nanotubes 11a may be configured such that a plurality of carbon nanotube units 11b is aggregated.

The carbon nanotube units 11b are a type of carbon allotrope in which carbon atoms are connected in a hexagonal honeycomb shape to form a tube, and the diameter thereof may be extremely small, on the nanometer scale. Specifically, the carbon nanotube units 11b may have a diameter of 10 nm to 50 nm. The carbon nanotube units 11b may have a length of 100 nm to 5 μm.

The carbon nanotube units 11b are excellent electrical and thermal conductors, and are high-strength and highly elastic materials based on a graphite crystal structure, and have a high specific surface area due to the nano-scale structures thereof. Specifically, the carbon nanotube units 11b may have a specific surface area of 150 m²/g to 300 m²/g.

Depending on the number of walls thereof, which are made of graphite, the carbon nanotube units 11b may be classified into single-walled carbon nanotubes (SWCNT), double-walled carbon nanotubes (DWCNT), and multiple-walled carbon nanotubes (MWCNT).

The present disclosure is characterized in that the sheet layer 11 is formed with bundle-type carbon nanotubes 11a obtained by aggregating carbon nanotube units, rather than the carbon nanotube units 11b. Compared to the carbon nanotube units 11b, the bundle-type carbon nanotubes 11a may be advantageous in the formation of a two-dimensional sheet layer 11.

The bundle-type carbon nanotubes 11a may have a diameter of 2 μm to 10 μm. Also, the bundle-type carbon nanotubes 11a may have a length of 50 μm to 100 μm.

Meanwhile, when the cathode 10 is composed exclusively of bundle-type carbon nanotubes 11a, the bundle-type carbon nanotubes 11a are densely stacked. In such case, we have discovered that the porosity of the cathode 10 may not increase sufficiently to realize a high-capacity lithium-air battery.

Hence, the present disclosure is characterized in that the porosity of the cathode 10 is increased by inserting a fibrous filler 13 into the sheet layer 11 including the bundle-type carbon nanotubes 11a. Due to the fibrous filler 13, the bundle-type carbon nanotubes 11a are not interconnected too closely, so the porosity may be sufficiently increased.

Moreover, the fibrous filler 13 functions as a support in the sheet layer 11. Therefore, according to the present disclosure, it is possible to construct the cathode 10 without using a binder.

Also, the present disclosure uses an electrically conductive material as the fibrous filler 13, so the internal electrical conductivity of the cathode 10 may be further increased. Specifically, the fibrous filler 13 may include at least one of carbon fiber, carbon nanofiber, vapor-grown carbon fiber (VGCF), silver wire, stainless wire, platinum wire or combinations thereof.

The fibrous filler 13 for implementing the above effects may be 1 mm to 10 mm in length.

The cathode 10 may include 95 wt % to 98 wt % of the bundle-type carbon nanotubes 11a and 2 wt % to 5 wt % of the fibrous filler 13. If the amount of the fibrous filler 13 exceeds 5 wt %, we have discovered that the relative amount of the bundle-type carbon nanotubes 11a may decrease, thus reducing the capacity of a battery. On the other hand, if the amount of the fibrous filler 13 is less than 2 wt %, we have discovered that the porosity of the cathode 10 may be lowered, which allows less oxygen, and the mechanical properties of the cathode 10 may be deteriorated.

The cathode 10 thus configured may have a porosity of 75% to 90%.

The anode 20, which is a site capable of depositing and dissociating lithium (Li), is configured to dissociate lithium ions during discharging and receive lithium ions during charging.

The anode 20 may include lithium metal or a lithium-metal-based alloy. The alloy may be an alloy of lithium and at least one of sodium (Na), potassium (K), rubidium (Rb), cesium (Cs), francium (Fr), beryllium (Be), magnesium (Mg), calcium (Ca), strontium (Sr), barium (Ba), radium (Ra), aluminum (Al), tin (Sn) or combinations thereof.

The electrolyte 30 is usually provided between the cathode 10 and the anode 20, but it is also possible for some or all of the electrolyte 30 to be incorporated into the cathode 10 and/or the anode 20 due to the properties thereof as a liquid, rather than a solid. Also, when a separator (not shown) is present, the electrolyte may be incorporated into the separator.

The electrolyte 30 may include a lithium salt. The lithium salt is dissolved in a solvent, and may act as a source of lithium ions in the battery, or may serve to promote the movement of lithium ions.

The lithium salt may include at least one of LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiF, LiBr, LiCl, LiI, LiB(C₂O₄)₂, LiCF₃SO₃, LiN(SO₂CF₃)₂(LiTFSI), LiN(SO₂C₂F₅)₂, LiC(SO₂CF₃)₃ or combinations thereof.

Meanwhile, the electrolyte 30 may be classified into an aqueous electrolyte and a non-aqueous electrolyte depending on the type of solvent. Specifically, the aqueous electrolyte may be in a form in which the lithium salt is included in water, and the non-aqueous electrolyte may be in a form in which the lithium salt is included in an organic solvent.

The organic solvent may include at least one of a carbonate-based solvent, an ester-based solvent, an ether-based solvent, a ketone-based solvent, an organosulfur-based solvent, an organophosphorus-based solvent, an aprotic solvent or combinations thereof.

The lithium-air battery 1 according to the present disclosure may further include a separator (not shown) provided between the cathode 10 and the anode 20. The separator may be used without limitation, so long as it is able to separate or insulate the cathode 10 and the anode 20 from each other and to block other materials while passing lithium ions alone therethrough. For example, a nonwoven fabric formed of a polypropylene material, a polymer nonwoven fabric such as a nonwoven fabric formed of a polyphenylene sulfide material, or a porous film of an olefin resin such as polyethylene or polypropylene may be used.

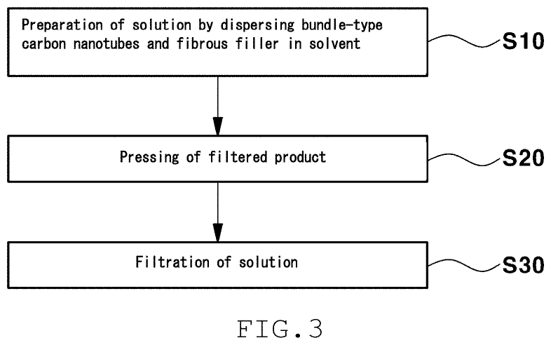

FIG. 3 is a flowchart showing the process of manufacturing the cathode according to the present disclosure. With reference thereto, the method of manufacturing the cathode may include preparing a solution by dispersing bundle-type carbon nanotubes and a fibrous filler in a solvent (S10), filtering the solution (S20), and pressing the filtered product (S30).

The bundle-type carbon nanotubes and the fibrous filler are as described above, and thus a description thereof will be omitted below.

The solution may be prepared by mixing bundle-type carbon nanotubes and a fibrous filler to afford a paste and then dispersing the paste in a solvent.

The solvent is not particularly limited, and, for example, an aqueous solvent may be used.

Also, the solution may be irradiated with ultrasonic waves, whereby the paste, particularly the bundle-type carbon nanotubes and the fibrous filler, may be uniformly dispersed. The conditions for ultrasonic irradiation are not particularly limited, and ultrasonic waves having a frequency that does not affect the paste may be applied for sufficient time to disperse the paste.

Thereafter, the solution may be filtered. The filtered product may include a sheet layer and the fibrous filler present in the sheet layer.

The sheet layer, having a network structure in which the bundle-type carbon nanotubes are interconnected, is formed through filtration. Specifically, when the bundle-type carbon nanotubes are added to an aqueous solvent, hydrogen bonding is formed between the bundle-type carbon nanotubes, and the aqueous solvent is removed through filtration, whereby a Van der Waals force is generated between the bundle-type carbon nanotubes, so a sheet layer having a network structure is formed.

Meanwhile, in the filtration process, the bundle-type carbon nanotubes form a network structure, and simultaneously, the fibrous filler is inserted between the bundle-type carbon nanotubes to serve as a support. Moreover, since the fibrous filler inhibits the bundle-type carbon nanotubes from being excessively densely stacked, the porosity of the sheet layer may be increased to an appropriate level.

Thereafter, the filtered product may be dried to completely remove the solvent. The filtered and dried product may be pressed, thereby obtaining a high-density cathode.

A better understanding of the present disclosure will be given through the following examples, which are merely set forth to illustrate the present disclosure but are not to be construed as limiting the scope of the present disclosure.

### Example 1 to Example 3

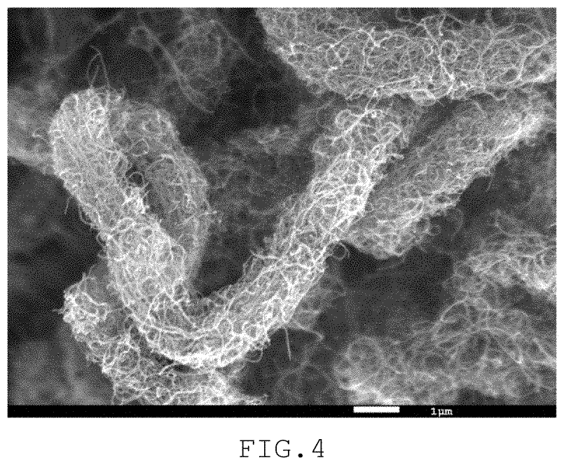

A paste was prepared by mixing bundle-type carbon nanotubes and carbon fibers. FIG. 4 is a scanning electron microscope (SEM) image showing the bundle-type carbon nanotubes. Here, the amount of the carbon fiber was adjusted to 2 wt % (Example 1), 3 wt % (Example 2) and 4 wt % (Example 3). Also, the bundle-type carbon nanotubes that were used had an average diameter of 2 to 4 μm and a length of 60 to 80 μm, and the carbon fibers that were used had a length of 3 mm.

The paste was added to water as an aqueous solvent. The product thereof was irradiated with ultrasonic waves to afford a solution in which the paste was uniformly dispersed in water.

The solution was filtered using a glass fiber filter to remove the solvent. The filtered product was separated from the glass fiber filter and then dried to completely remove the residual solvent.

The filtered product was hot-pressed, thereby obtaining a high-density cathode for a lithium-air battery. The amount of the carbon that was loaded on the cathode was adjusted to about 10 mg/cm², and the thickness thereof was about 200 μm.

### Comparative Example 1

A cathode for a lithium-air battery was manufactured in the same manner as in the above Examples, with the exception that carbon fibers were not used. Briefly, the cathode of Comparative Example 1 was composed exclusively of bundle-type carbon nanotubes.

### Comparative Example 2

A cathode for a lithium-air battery was manufactured in the same manner as in Example 3, with the exception that 4 wt % of polytetrafluoroethylene (PTFE) as a polymer binder was used, in lieu of carbon fibers.

### Test Example

The tensile strength, surface resistance, and porosity of the cathodes of Example 1 to Example 3 and Comparative Example 1 and Comparative Example 2 were measured. The tensile strength was measured using a micro tensile testing machine (BT1-FPLV.00, Zwick/Roell, Germany) equipped with a 500 N load cell based on ASTM D882-10, the surface resistance was measured through a 4-point probe method, and the porosity was measured using a Hg porosimeter. The results thereof are shown in Table 1 below.

Meanwhile, a lithium-air battery was manufactured using the cathode of each of Example 1 to Example 3 and Comparative Example 1 and Comparative Example 2, an anode, a separator interposed between the cathode and the anode, and an electrolyte incorporated into the separator. Lithium metal was used as the anode and 1 M LiNO₃ in DMAc was used as the electrolyte. The discharge capacity of each lithium-air battery was measured. The discharge capacity was measured under conditions of a 100% oxygen (O₂) atmosphere, pressure of 2 bar, and current density of 0.5 mA/cm². The results thereof are shown in Table 1 below.

TABLE 1

| | Com- | | | | Com- |
|---|---|---|---|---|---|
| | parative | Example | Example | Example | parative |
| Classification | Example 1 | 1 | 2 | 3 | Example 2 |
| Tensile | 3 | 8 | 10 | 14 | 17 |
| strength | | | | | |
| [Mpa] | | | | | |
| Surface | 0.7 | 1.2 | 2.5 | 4 | 12 |
| resistance | | | | | |
| [Ω/sq.] | | | | | |
| Porosity [%] | 71 | 76 | 81 | 84 | 68 |
| Discharge | 19 | 21 | 25 | 23 | 20 |
| capacity | | | | | |
| [mAh/cm²] | | | | | |

As is apparent from Table 1, in Comparative Example 1, composed exclusively of the bundle-type carbon nanotubes, the surface resistance is the lowest, but the porosity is so low that the introduction of oxygen is difficult, and the discharge capacity is low.

In Comparative Example 2, good tensile strength is exhibited, but the polymer binder polytetrafluoroethylene (PTFE) acts as a resistor, resulting in high surface resistance and very low porosity.

However, Example 1 to Example 3 exhibit high tensile strength compared to Comparative Example 1, very low surface resistance compared to Comparative Example 2, and high porosity and discharge capacity compared to Comparative Examples 1 and 2. Therefore, according to the present disclosure, it can be concluded that a lithium-air battery having superior mechanical properties, low cell resistance, and high porosity and discharge capacity can be obtained.

The cathodes of Example 2 and Comparative Example 1 were observed with SEM.

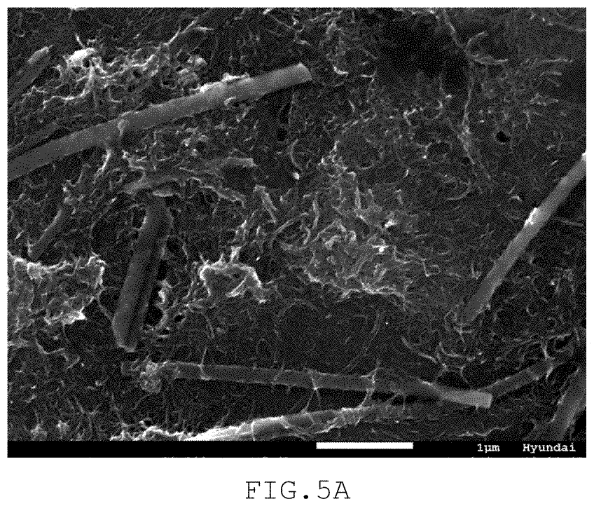

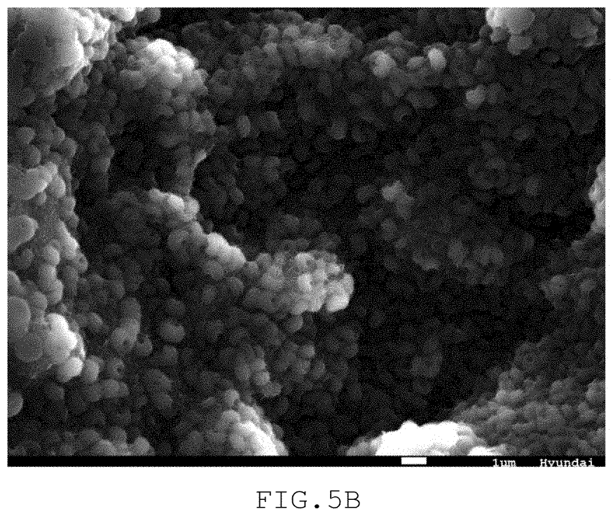

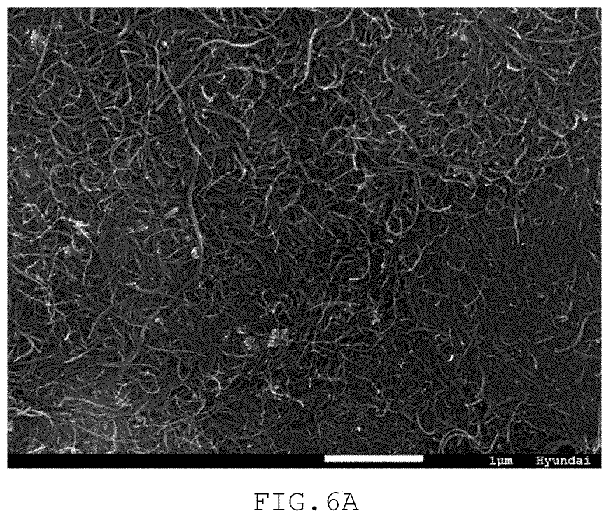

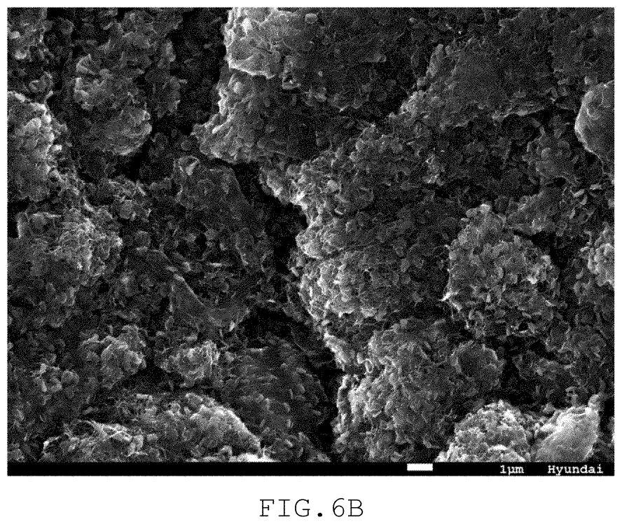

FIG. 5A shows the cathode for a lithium-air battery of Example 2 and FIG. 5B shows the above cathode after formation of the discharge product. FIG. 6A shows the cathode for a lithium-air battery of Comparative Example 1 and FIG. 6B shows the above cathode after formation of the discharge product.

With reference to FIG. 5A, the cathode according to the present disclosure includes a sheet layer composed of bundle-type carbon nanotubes and a fibrous filler inserted into the sheet layer. With reference to FIG. 5B, the discharge product is uniformly formed without cracking in the cathode according to the present disclosure.

In contrast, with reference to FIG. 6A, the cathode of Comparative Example 1 is composed exclusively of the bundle-type carbon nanotubes, and no fibrous filler is found therein. With reference to FIG. 6B, cracks are generated due to the formation of the discharge product in the cathode of Comparative Example 1.

As described hereinbefore, the present disclosure has been described in detail with respect to test examples and various forms. However, the scope of the present disclosure is not limited to the aforementioned test examples and examples, and various modifications and improved modes of the present disclosure using the basic concept of the present disclosure defined in the accompanying claims are also incorporated in the scope of the present disclosure.

What is claimed is:

1. A cathode for a lithium-air battery, the cathode comprising:
a sheet layer having bundle-type carbon nanotubes that interconnect and form a network structure; and
a fibrous filler that is electrically conductive and intertwined with the bundle-type carbon nanotubes in the sheet layer.

2. The cathode of claim 1, wherein the bundle-type carbon nanotubes comprise a plurality of carbon nanotube units that are aggregated, and the plurality of carbon nanotube units have a diameter of 10 nm to 50 nm.

3. The cathode of claim 2, wherein the plurality of carbon nanotube units each have a length of 100 nm to 5 μm.

4. The cathode of claim 2, wherein the plurality of carbon nanotube units each have a specific surface area of 150 m²/g to 300 m²/g.

5. The cathode of claim 1, wherein the bundle-type carbon nanotubes have a diameter of 2 μm to 10 μm.

6. The cathode of claim 1, wherein the bundle-type carbon nanotubes have a length of 50 μm to 100 μm.

7. The cathode of claim 1, wherein the fibrous filler comprises at least one of carbon fiber, carbon nanofiber, vapor-grown carbon fiber (VGCF), silver wire, stainless wire, platinum wire or combinations thereof.

8. The cathode of claim 1, wherein the fibrous filler has a length of 1 mm to 10 mm.

9. The cathode of claim 1, further comprising:
95 wt % to 98 wt % of the bundle-type carbon nanotubes; and
2 wt % to 5 wt % of the fibrous filler.

10. The cathode of claim 1, wherein the cathode has a porosity of 75% to 90%.

11. A method of manufacturing a cathode for a lithium-air battery, the method comprising:
preparing a solution by dispersing bundle-type carbon nanotubes and a fibrous filler in a solvent; and
filtering the solution,
wherein:
a filtered product comprises a sheet layer having the bundle-type carbon nanotubes that interconnect and form a network structure; and
the fibrous filler that is electrically conductive and intertwined with the bundle-type carbon nanotubes in the sheet layer.

12. The method of claim 11, wherein preparing the solution comprises:
mixing the bundle-type carbon nanotubes and the fibrous filler to produce a paste; and
dispersing the paste in the solvent.

13. The method of claim 11, wherein dispersing the bundle-type carbon nanotubes and the fibrous filler in the solvent comprises irradiating the solution with ultrasonic waves.

14. The method of claim 11, further comprising pressing the filtered product.

15. The method of claim 11, wherein:
the bundle-type carbon nanotubes comprise a plurality of carbon nanotube units that are aggregated, and
the plurality of carbon nanotube units each have a diameter of 10 nm to 50 nm, a length of 50 μm to 100 μm, and a specific surface area of 150 m²/g to 300 m²/g.

16. The method of claim 11, wherein the bundle-type carbon nanotubes have a diameter of 2 μm to 10 μm and a length of 50 μm to 100 μm.

17. The method of claim 11, wherein the fibrous filler comprises at least one of carbon fiber, carbon nanofiber, vapor-grown carbon fiber (VGCF), silver wire, stainless wire, platinum wire or combinations thereof.

18. The method of claim 11, wherein the fibrous filler has a length of 1 mm to 10 mm.

19. The method of claim 11, wherein the cathode comprises 95 wt % to 98 wt % of the bundle-type carbon nanotubes and 2 wt % to 5 wt % of the fibrous filler.

20. The method of claim 11, wherein the cathode has a porosity of 75% to 90%.
